(19) United States
(12) Patent Application Publication
(10) Pub. No.: US 2007/0285337 A1
(43) Pub. Date: Dec. 13, 2007

(54) Visual display screen apparatus

(76) Inventor: Alan Maddock, Amersham (GB)

Correspondence Address: DAVID ODELL SIMMONS, 7637 PARKVIEW CIRCLE, AUSTIN, TX, 78731, US

(21) Appl. No.: 11/451,048

(22) Filed: Jun. 12, 2006

(51) Int. Cl. G09G 5/00

(52) U.S. Cl. 345/1.1

(57) ABSTRACT

A visual display screen apparatus including a support member and a visual display screen for collapsible displays such as flexible projection screen systems and light-emissive screens screen systems in combination with the elongated support member. The elongated support member includes or consists of a strip of material having an arcuate cross-sectional shape and exhibiting sufficient rigidity to act as a support for the visual display screen. Within a region of the strip of material where it transitions from having an arcuate cross-sectional shape to a flat cross-sectional shape, the strip of material exhibits a significant reduction in its rigidity and can be readily bent for enabling rolling and/or folding of the elongated support member for enabling the visual display screen to be rolled, folded and/or collapsed for storage and transport.

### FIELD OF THE DISCLOSURE

The disclosures made herein relate generally to retractable (i.e., foldable, collapsible and/or rollable) visual display screen assemblies and, more particularly, to support apparatuses that enable a visual display screen of a electronic media presentation system (e.g., rear projection screen, front projection screen, reflective screen or emissive screen) to be retractable such that the visual display screen is selectively extendable and retractable to provide for portability and storage.

### BACKGROUND

Personal electronic devices such as PDAs (Personal Digital Assistants), portable gaming consoles, DVD players, digital cameras, camcorders and media players for Internet, music and/or TV content have gained widespread acceptance among consumers. Furthermore, it has become commonplace for such personal electronic devices be of a relatively small overall size, thus enabling them to be handheld and readily carried on a person's body (e.g., in a pocket, in a backpack, in a device-specific carrying case, etc). As a result of the relatively small overall size of such handheld personal electronic devices, it is common for them to have a relatively small visual display screen (e.g., often about 2 inches measured diagonally).

The relatively small visual display screen of a handheld personal electronic device is dictated by the relatively small overall size of a handheld personal electronic device. However, the relatively small size of the visual display screen is limiting with respect to utility of the handheld personal electronic device. Most notably, the relatively small size of the visual display screen limits the ability of a user to readily view and share rich content available via the handheld personal electronic device because the visual display screen is simply too small for any viewer to visualise the available detail of the content available or for two or more people to view it simultaneously.

Various different configurations of conventional retractable visual display screen assemblies—large and small format—are well known. Furthermore, many different conventional screen support structures are used for securing a screen of such a conventional visual display screen assembly in an open configuration and enabling the screen assemblies to be retractable for enabling storage during non-use. Retractable is defined herein to include being foldable, collapsible and/or rollable. These conventional retractable visual display screens and conventional screen support structures exhibit one or more shortcomings with respect to overall size of the visual display screen (e.g., being too large for required portability), providing suitably rigidity to be self-supporting and capable of maintaining the screen sufficiently planar, maintaining the entire viewable portion of the visual display screen in a flat orientation, being susceptible to damage at edges of the screen, providing a simple and effective means of enabling extension and retraction of the screen, and providing a simple and effective means of securing the screen in an extended configuration.

An exemplary embodiment of these conventional retractable visual display screens is a large format roll-up visual display screen assembly. Such conventional large format roll-up visual display screen assembly are often as wide a 60″ or more or may be smaller than 60 inches. Regardless of size, their overall shortcomings are common. Such a roll-up visual display screen includes an enclosure with a drum (or dowel) to which a first end of a rollable visual display screen is attached. The visual display screen is wound around the drum within the enclosure when not in use. It is extended by the user pulling on a cross-member attached to a second end of the visual display screen that is opposite the first end of the visual display screen. In pulling the cross-member, the screen is unrolled off the drum and out of the enclosure. Various retention structures are known for retaining the cross-member and visual display screen in the open orientation. One example of such a retention structure is a retractable support member that extends between the enclosure and the cross-member and that is held in an extended orientation by friction, opposing springs or pressurized strut assemblies. Often, the drum is spring-biased such that the visual display screen is in the wound orientation, thus resulting in the visual display screen being under tension when secured in the open orientation. However, this tension alone provides some support to the screen material to retain it generally flat but typically does not prevent the tendency for the side edges of the visual display screen to curl inwards. Curling of the visual display screen results in distortion of an image projected or displayed upon the visual display screen.

Therefore, a retractable visual display screen assembly that overcomes one or more shortcomings associated with conventional retractable visual display screen assemblies and/or more needs associated with visual display screen assemblies in general are advantageous, desirable and useful.

### SUMMARY OF THE DISCLOSURE

Many types of portable deployable screens for visual display (i.e., a visual display screen) are available but have been of larger size (typically greater than 60 inches diagonal) for group viewing—such as wall-mounted roll-up front projection screens for conference room and home theatre use. However, a personal accessory display screen in accordance with the present invention is compact and highly hand-portable (e.g., pocket size). Such a small form factor implies that such screens are lightweight, retractable (e.g., collapsible, rollable and/or foldable to reduce their format) and are user-friendly with a rapid set-up and retraction. Typical user applications require a visual display screen in the range of 6 to 30 inches and be capable of, for example, being hung from a wall, supported on a table or being held in a hand.

A visual display screen in accordance with the present invention can operate with a pocket-sized projector in front of the visual display screen, with rear projection mode or with a light emissive screen (e.g., Organic-LED or Polymeric-LED on a flexible substrate). In addition to providing a compact form factor than conventional visual display screens, another requirement of a visual display screen in accordance with the present invention is to retain an acceptable degree of screen rigidity, tensioning and planarity when it is in a use configuration. Such a requirement is important because retractable visual display screens necessitate the use of a conformable material for the visual display screen. Known visual display screen material tends to retain fold lines from being folded or curvature (e.g., a curling inwards action along unsupported side edges of a roll-up screen) from being rolled when opened from a retracted configuration to the use configuration.

In accordance with the principles of the present invention, the foregoing and other objects are provided by a visual display screen apparatus that includes a support member capable of supporting its own weight plus that of an associated portion of a visual display screen (i.e., a self-supporting characteristic) and biasing itself to a straight and suitably rigid orientation (i.e., a self-biasing characteristic). More specifically, the present invention relates to a support member for a display screen that allows a visual display screen to be supported in a planar and tensioned manner and to be retracted (e.g., to be collapsed, rolled and/or folded) for achieving a smaller, more portable format such as for enabling transport and storage. Such a visual display screen apparatus has applicability for the display of image or data content and the screen material may be of a translucent/diffusion type for rear projection, a reflective/diffusion type for front projection, a light reflective or a light emissive type of screen where images are directly formed on the screen surface.

Accordingly, in at least one embodiment, it is an object of the present invention that a support member is provided for retractable visual display screen assemblies such that the elongated support member may exhibit a flexible condition while collapsed and a significantly more rigid condition when extended.

In at least one embodiment, it is an object of the present invention that a self-supported configuration of the elongated support member is suitably rigid to retain the screen in a sufficiently planar condition or to retain the screen edges in a sufficiently linear condition when in a use configuration.

In at least one embodiment, it is an object of the present invention that the construction and/or configuration of the elongated support member, if positioned adjacent or attached to the screen edges, be sufficiently rigid to provide protection to the screen and/or its edges from damage.

In at least one embodiment, it is an object of the present invention that the elongated support member be sufficiently rigid such as to prevent or significantly reduce the curling inwards of the side edges of a roll-up visual display screen through either direct attached of the elongated support members to such side edges or through suitable tensioning of the visual display screen.

In at least one embodiment, it is an object of the present invention that the elongated support member provides sufficiently rigid support such that the visual display screen material is tensioned between support members at opposing edges of a screen.

In at least one embodiment, it is an object of the present invention that the elongated support member provides sufficiently rigid support such that the visual display screen is supporting in a suitably planar and/or tensioned manner when extended upwards or laterally outwards from its retracted configuration.

In at least one embodiment, it is an object of the present invention that the elongated support member retains the screen in a use configuration without further retention mechanisms.

In at least one embodiment, it is an object of the present invention that the elongated support member includes rigid portions and self-biasing, self-supporting portions whereby the elongated support member is selectively foldable only between the rigid sections at the self-biasing, self-supporting sections.

In at least one embodiment, it is an object of the present invention that a segment of the elongated support member provides a bi-stable state exhibited as a ‘flipping’ action between a self-supported configuration state and a rolled or folded configuration.

In at least one embodiment, it is an object of the present invention that the elongated support member provides for folding or rolling of the visual display screen in a controlled and predictable manner so as to reduce the potential for damage to the visual display screen viewing surface and/or any optical coatings.

In at least one embodiment, it is an object of the present invention that a visual display screen apparatus in accordance with the present invention is integral with or a component of a media presentation system having a media presentation device (e.g., a video music player, an internet/TV/video mobile phone, etc) such that the visual display screen apparatus provides a considerably larger viewing area than does a screen of the media device itself.

In at least one embodiment, it is an object of the present invention that a housing of a visual display screen in accordance with the present invention is integral with or engagable with a housing of the media presentation device.

Turning now to specific embodiments of the present invention, in one embodiment, a visual display screen apparatus comprises a visual display screen and an elongated support member. The visual display screen is constructed from material exhibiting suitable conformability for enabling the visual display screen to be at least one of rollable, collapsible and foldable. The visual display screen material is at least one of rolled, collapsed and folded when a viewable portion of the visual display screen is in a retracted configuration and is generally flat when the viewable portion of the visual display screen is in a use configuration. The elongated support member has the visual display screen engaged therewith. The elongated support member includes a strip of elastically bendable material. The strip of material exhibits a self-supporting characteristic when in a non-bent configuration such that the elongated support member extends in an effectively straight and rigid manner thereby supporting the viewable portion of the visual display screen in the use configuration. The strip of material exhibits a self-biasing characteristic when a bending force is applied thereto for resiliently moving the strip of material from the non-bent configuration to a bent configuration thereby enabling the viewable portion of the visual display screen to be changed to the retracted configuration.

In another embodiment of the present invention, a visual display screen assembly comprises a visual display screen and an elongated support member. The visual display screen is constructed from material exhibiting suitable conformability for enabling the visual display screen to be at least one of rollable, collapsible and foldable. The visual display screen material is at least one of rolled, collapsed and folded when a viewable portion of the visual display screen is in a retracted configuration and is generally flat when the viewable portion of the visual display screen is in a use configuration. The elongated support member has the visual display screen engaged therewith. The elongated support member includes a strip of elastically bendable material having spaced-apart major surfaces. A first one of the major surfaces has a convex cross-sectional shape and a second one of the major surfaces has a concave cross-sectional shape. The elastically bendable material and the major surface profiles jointly enable the strip of material to exhibit self-biasing, self-supporting and elastically bendable characteristics whereby the elongated support member is self-biased to a substantially straight, essentially rigid orientation when the viewable portion of the visual display screen is in the use configuration and is elastically bent when the viewable portion of the visual display screen is in the retracted configuration.

In another embodiment of the present invention, a visual display screen assembly comprises a visual display screen and an elongated support member. The visual display screen is constructed from material exhibiting suitable conformability for enabling the visual display screen to be at least one of rollable, collapsible and foldable. The visual display screen material is at least one of rolled, collapsed and folded when a viewable portion of the visual display screen is in a retracted configuration and is generally flat when the viewable portion of the visual display screen is in a use configuration. The elongated support member includes an elastically bendable self-supporting strip of material having spaced-apart major faces. The strip of material extends at least partially along a length of the viewable portion of the visual display screen. When the viewable portion of the visual display screen is in the use configuration, the strip of material is rotatable between a first orientation such that the major faces of the strip of material are generally non-coplanar with a major face of the viewable portion of the visual display screen and a second orientation such that the major faces of the strip of material are substantially co-planar with the major face of the viewable portion of the visual display screen.

In another embodiment of the present invention, a visual display screen apparatus comprises a visual display screen, spaced-apart frame structures, an elongated support member and means for pivoting. The visual display screen is constructed from a foldable material. The visual display screen material is folded when a viewable portion of the visual display screen is in a retracted configuration and is unfolded when the viewable portion of the visual display screen is in a use configuration. The visual display screen is attached to the frame structures. The elongated support member has the visual display screen engaged therewith. The elongated support member includes a strip of elastically bendable material having spaced-apart opposed major surfaces. A first one of the major surfaces has a convex cross-sectional shape and a second one of the major surfaces has a concave cross-sectional shape. The elastically bendable material and the major surface configurations jointly enable the strip of material to exhibit self-biasing, self-supporting and elastically bendable characteristics whereby the elongated support member is self-biased to a substantially straight, essentially rigid orientation when the viewable portion of the visual display screen is in the use configuration and is elastically bent when the viewable portion of the visual display screen is in the retracted configuration. The means for pivoting is connected between the frame structures for enabling a first one of the frame structures to pivot with respect to a second one of the frame structures.

In another embodiment of the present invention, a visual display screen apparatus comprises a housing, a drum, spaced-apart elongated support members and a visual display screen. The drum is rotatably engaged with the housing. The spaced-apart elongated support members are each attached at a first end portion thereof to the drum such that the elongated support members are rollable onto and unrollable from the drum. Each one of the elongated support members exhibits a self-supporting characteristic when unrolled from the drum thereby causing an unrolled portion of the elongated support members to extend from the housing in an effectively unbent and rigid manner. Each one of the elongated support members exhibits an elastically bendable characteristic when rolled onto the drum thereby allowing each one of the elongated support members to be rolled on to the drum. The visual display screen has spaced-apart side edge portions and spaced-apart end portions. A first one of the edge portions extends generally parallel with a first one of the elongated support members and a second one of the edge portions extends generally parallel with a second one of the elongated support members. A first one of the end portions is attached to the drum and the visual display screen is made from a conformable material thereby allowing the visual display screen to be rolled onto and unrolled from the drum in conjunction with the elongated support members.

These and other objects, embodiments, advantages arid/or distinctions of the present invention will become readily apparent upon further review of the following specification, associated drawings and appended claims.

### BRIEF DESCRIPTION OF THE DRAWINGS

FIG. 1 is a perspective view of an embodiment of a free-folding visual display screen apparatus in accordance with the present invention.

FIG. 2 is a cross-sectional view taken along the line 2-2 in FIG. 1.

FIG. 3 is a cross-sectional view taken along the line 3-3 in FIG. 1.

FIG. 4 is a perspective view of an embodiment of a multi-fold visual display screen apparatus in accordance with the present invention.

FIG. 5 is a cross-sectional view taken along the line 5-5 in FIG. 2.

FIG. 6 is a cross-sectional view taken along the line 6-6 in FIG. 2 with a cutaway portion showing the support member.

FIG. 7 is a perspective view of an embodiment of a pull-out visual display screen apparatus in accordance with the present invention.

FIG. 8 is a cross-sectional view taken along the line 8-8 in FIG. 7.

FIG. 9 is a cross-sectional view taken along the line 9-9 in FIG. 7.

FIG. 10 is a perspective view of an embodiment of a high-planarity pull-out visual display screen apparatus in accordance with the present invention.

FIG. 11 is a cross-sectional view taken along the line 11-11 in FIG. 10.

FIG. 12 is a cross-sectional view taken along the line 12-12 in FIG. 10.

FIG. 13 is a front perspective view of an embodiment of a hinged visual display screen apparatus in accordance with the present invention.

FIG. 14 is a rear plan view of the hinged visual display screen apparatus shown in FIG. 13.

FIG. 15 is a cross-sectional view taken along the line 15-15 in FIG. 14, which shows frame structures of the hinged visual display-screen apparatus in a use configuration.

FIG. 16 is a cross-sectional view showing the frame structures of the hinged visual display screen apparatus shown in FIGS. 13 and 14 in a retracted configuration.

FIG. 17 is a cross-sectional view showing an embodiment of an externally-stressed formed strip in accordance with the present invention is shown.

FIG. 18 is a cross-sectional view of an embodiment of a gas pressure controlled elongated member in accordance with the present invention, wherein gas pressure is at a level whereby strips of elastically deformable material have an arcuate cross-sectional shape.

FIG. 19 is across-sectional view of the gas pressure controlled elongated member of FIG. 18, wherein gas pressure is at a level whereby strips of elastically deformable material have a generally flat cross-sectional shape.

### DETAILED DESCRIPTION OF THE DRAWING FIGURES

As is discussed in detail below and illustrated in the associated drawings, visual display screens in accordance with the present invention include one or more elongated support members each having a strip of elastically bendable material. The strip of material is shaped in a manner such that it exhibits self-supporting, self-biasing and elastically bendable characteristics, thereby imparting such characteristics on the elongated support member. Through these characteristics, visual display screens in accordance with the present invention advantageously provide retraction functionality that is not provided for by conventional visual display screens and provide for novel, useful and previously unfulfilled utility in a variety of media presentation applications.

Broadly speaking, self-supporting in accordance with the present invention refers to the strip of material being in a non-bent configuration whereby it extends in an effectively straight and rigid manner that supports and maintains planarity of at least a portion of a visual display screen (e.g., material suitably configured for having an image displayed thereon and for being rolled, folded and/or collapsed). Broadly speaking, self-biasing in accordance with the present invention refers to bending of the strip of material from a non-bent configuration (i.e., extending in an effectively straight and rigid manner) to a bent configuration causing the strip of material to generate internal forces that urge strip of material from the bent configuration to the non-bent configuration. As is discussed below in greater detail, such self-biasing, self-supporting and elastically bendable characteristics enable a visual display screen to be selectively maintained in a use configuration (i.e., support in a flat, planar manner) and moved to a retracted configuration (i.e., the visual display screen material being collapsed, folded and/or rolled). Accordingly, ancillary support members are not required for supporting the visual display screen in the use configuration.

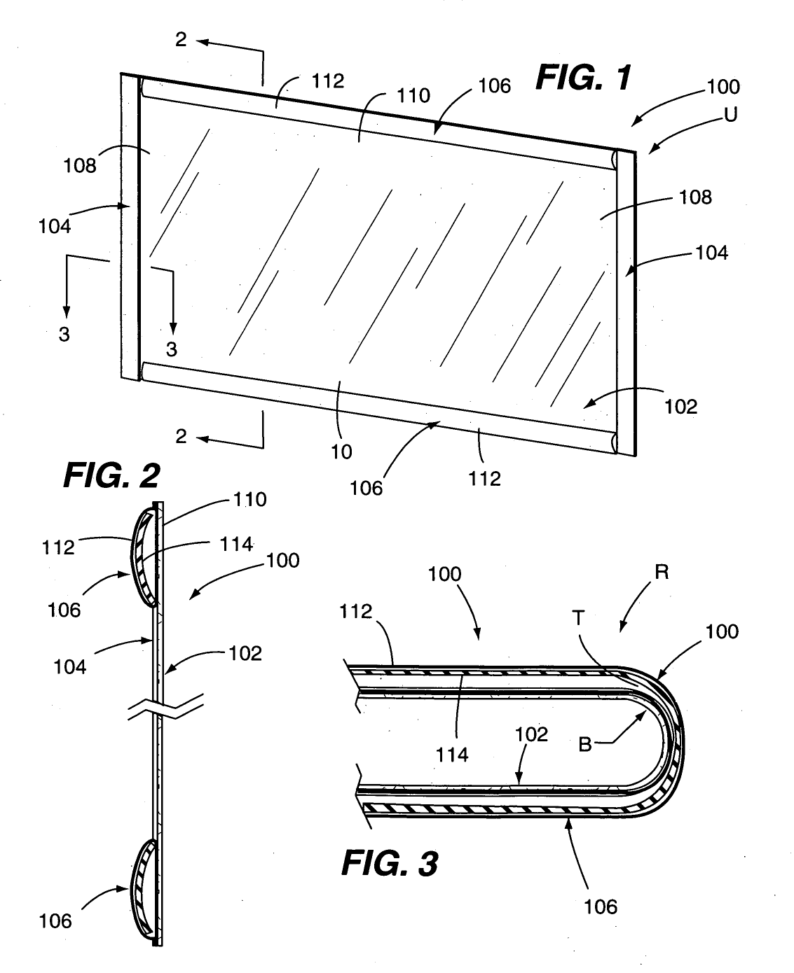

Turning now to discussion of specific drawing figures, FIGS. 1-3 show various aspects of a first embodiment of a visual display screen apparatus in accordance with the present invention, which is referred to herein as the free-folding visual display screen apparatus 100. The free-folding visual display screen apparatus 100 includes a visual display screen 102, non-bending members 104 and support members 106. The visual display screen 102 is constructed from material exhibiting suitable conformability for enabling the visual display screen to be rollable, collapsible (e.g., pleated, draped, sagged, etc) and foldable. The material of the visual display screen making up a viewable portion (i.e., the portion that is viewable) of the visual display screen 102 is generally planar (i.e., flat) when the visual display screen 102 is in a use configuration U (FIG. 1).

The visual display screen 102 has a generally rectangular shape with spaced-apart end portions 108 and spaced-apart side portions 110. As depicted, the spaced-apart end portions 108 extend generally perpendicular to the spaced-apart side portions 110. The non-bending members 104 are each attached to a respective one of the spaced-apart end portions 108 of the visual display screen 102, extending effectively an entire distance between the spaced-apart side portions of the visual display screen 102. The elongated support members 106 are each attached to a respective one of the spaced-apart side portions 110 of the visual display screen 102, extending effectively an entire distance between the spaced-apart end portions of the visual display screen 102. It is disclosed herein that non-bending is defined herein to be a relative term in it refers to being essentially non-bending in view of forces applied thereto by the visual display screen 102 and/or support members during normal and anticipated use of the visual display screen apparatus 100. Examples of a non-bending member include, but are not limited to, an elongated member made injection molded from plastic, an elongated member cast from aluminum, an elongated member extruded from plastic, and the like.

As shown in FIGS. 2 and 3, each one of the elongated support members 106 includes a sheath 112 and a strip 114 of elastically bendable material (e.g., spring steel) disposed within the sheath 112 (e.g., sleeve formed of a polymeric material). The sheath 112 is attached to the visual display screen 102 by means such as, for example, adhesive, thermal bonding, stitching, ultrasonic welding, heat staking, and the like. In this manner, the sheath 112 serves as a means for facilitating attachment of the strip 114 to the visual display screen 102. Examples of a sheath in accordance with the present invention include, but are not limited to, material in the form of a sleeve and material in the form of a tube. It is disclosed herein that the sheath 112 may be omitted and the strip 114 may be attached directly to the visual display screen 102. It is also disclosed herein that the strip and/or sheath 112 may be attached to the non-bending members 104 and not to the visual display screen 102.

The strip 114 has spaced-apart major surfaces. As best seen in FIG. 2, a first one of the major surfaces has a convex cross-sectional shape and a second one of the major surfaces has a concave cross-sectional shape. Furthermore, the strip 114 has an essentially constant cross-sectional thickness such that non-bent portion of the strip 114 have an arcuate cross sectional shape. In view of the cross-sectional shape of the'strip 114 and the elastically bendable material, the strip 114 exhibits self-biasing, self-supporting and elastically bendable characteristics in accordance with the present invention whereby the elongated support member is self-biased to a substantially straight, essentially rigid orientation (FIG. 1) when the viewable portion of the visual display screen 102 is in the use configuration U and is elastically bent (FIG. 3) when a bending force is applied thereto thus enabling the visual display screen 102 to be moved to a retracted configuration R (FIG. 3). As shown in FIG. 3, bending of the'strip 114 causes the bent portion of the strip 114 to elastically transition from the arcuate cross section profile to a generally flat cross-sectional shape in the transition region T (i.e., elastically bendable characteristic). Furthermore, as shown in FIG. 3, bending of the strip 114 causes an attached portion of the visual display screen 102 to corresponding bend in a uniform and controlled manner such that the potential for the visual display screen 102 being damaged and distorted is limited. Bending of the strip 114 may be facilitated in a manner that causes the visual display screen 102 and the elongated support members 106 to be rolled, folded and or collapsed.

In one embodiment of the present invention, the strip 114 is a strip of generally uniform thickness spring steel that is pre-formed to have an arcuate cross-sectional shape. Such a preformed strip of material is used in handyman-roll-up measuring tapes (i.e., a tape measure) where the tape is a thin steel strip made of spring-steel with an arcuate cross-sectional shape (i.e. an arched cross-sectional shape) that enables it to retain a high rigidity when extended linearly. As the strip is retracted into the case of the tape measure, the strip transitions from an arcuate cross sectional profile to a generally flat-cross sectional profile, thus enabling it to roll readily onto a drum inside the case.

A strip of material providing self-biasing, self-supporting and elastically bendable characteristics as described above, it also referred to herein as a “formed strip”. Such a formed strip as specifically configured for used in a visual display screen apparatus in accordance with the present invention will have a relatively high resistance to bending when extended straight for providing support to retain edge portions of a visual display screen in a flat condition and/or further to readily support the viewable portion in a free-standing manner (e.g., no ancillary support members required). Therefore, a formed strip, when in an extended orientation, will have sufficient rigidity to serve as a support to retain a display screen open, planar and freestanding against the force of gravity and against the force of possible screen tensioning methods.

Referring to FIG. 3, the strip 114 of material has a minimum bend radius B for being elastically bent to preclude plastic deformation of the strip 114 when being bent. It is disclosed herein that a prescribed segment of the strip 114 (e.g., segment S) can be intentionally been subjected to bending at a radius less than the minimum bend radius B such that the prescribed segment is plastically deformed. By controlling the degree of plastic deformation (e.g., by controlling the size of the bed radius), the plastic deformation causes the prescribed segment of the strip 114 to be a preferential bend location of the elongated support member 106 while still exhibiting the self-supporting, self-biasing and elastically bendable characteristics in accordance with the present invention. Such a preferred bend location can be suitably formed for creating a portion of the strip 114 that is an integrally formed hinge region (i.e., a preferential fold location) or a self-rolling region (i.e., a region that rolls into a coil when a suitable bending force is applied thereto). The plastic deformation of the material imparts a ‘bi-stable’ characteristic upon the elongated support member 106. Bi-stable is defined herein to mean that the strip 114 is stable when in the straight, rigid configuration and when in a bent configuration and that with a minimal applied force, the strip 114 ‘toggles’ from one configuration to the other. In this manner, the strip 114 is capable of supporting a flexible screen when in an open configuration and also bending it into a closed configuration and maintaining such closed configuration. Such a bi-stable characteristic is useful in that the elongated support members 106 can be configured for including “fold-over hinges” that enable the visual display screen 102 to fold or wrap-around a base or other object (e.g., a media display device such as, for example, a wireless phone).

More broadly, a formed strip in accordance with the present invention may be formed such that it has an arcuate cross sectional profile along a specific portion of its length (e.g., its entire length) and includes internal bending stresses along the specific portion of its length that urge the specific portion of length into a bent (e.g., folded or rolled) configuration. The portion of length having internal bending stresses and having an arcuate cross sectional profile is hereinafter referred to as the internally stressed length of the arcuate strip. Such internal bending stresses can be induced by any number of known manufacturing processes (e.g., plastic deformation below a minimum bend radius, hot rolling around mandrel with cold quench, etc). To provide the internally stressed length of the arcuate strip with self-supporting characteristics, the internally stressed length of the arcuate strip is configured such that the level of applied bending force required to cause the arcuate cross-sectional shape to flatten and, thus, enable bending dominates over the internal bending stresses. As such, when external force is applied on the internally stressed length of the arcuate strip for moving the internally stressed length of the arcuate strip to a generally straight configuration, the internally stressed length of the arcuate strip exhibits self-supporting characteristics by virtue of the internal bending stresses being less than the level of applied bending force required to cause the arcuate cross-sectional shape to flatten. A suitable externally applied force in combination with the internal bending stresses will cause the, arcuate cross-sectional shape to flatten, at which point, the internal bending stresses will cause the internally stressed length of the arcuate strip to bend into a folded or rolled configuration without the need for further application of the external applied force.

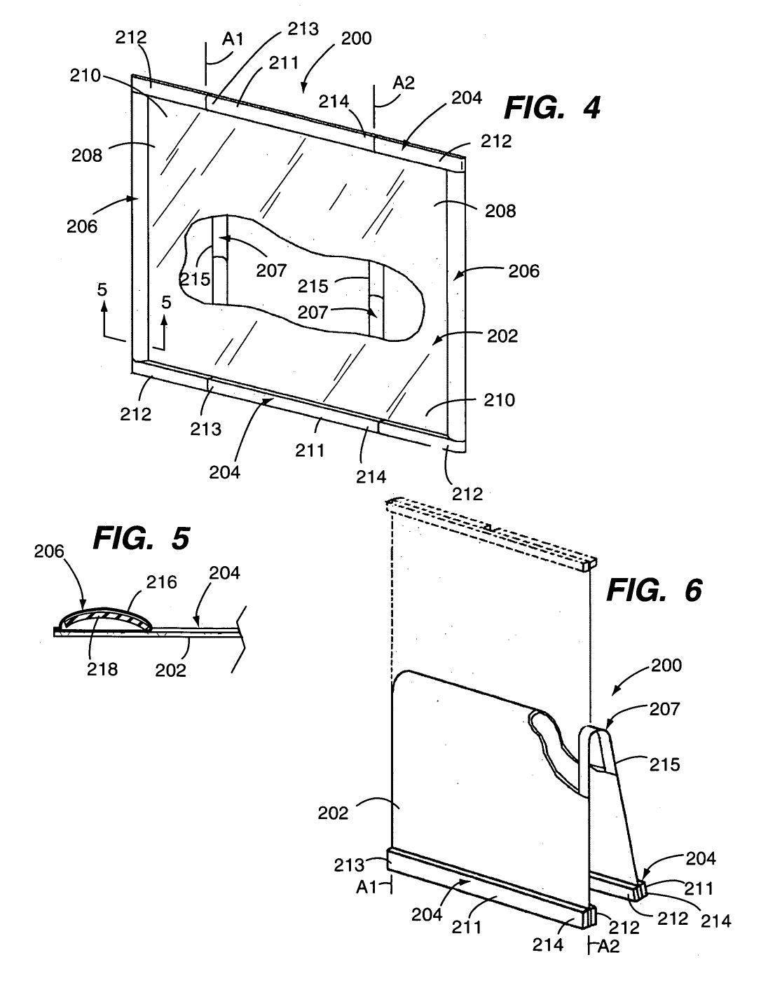

Referring now to FIGS. 4-6, various aspects of a second embodiment of a visual display screen apparatus in accordance with the present invention is shown, which is referred to herein as the multi-fold visual display screen apparatus 200. The multi-fold visual display screen apparatus 200 includes a visual display screen 202, hinged members 204, outboard support members 206 and inboard support members 207. The visual display screen 202 is constructed from material exhibiting suitable conformability for enabling the visual display screen to be rollable, collapsible (e.g., pleated, draped, sagged, etc) and foldable. The material of the visual display screen making up a viewable portion (i.e., the portion that is viewable) of the visual display screen 202 is generally planar (i.e., flat) when the visual display screen 202 is in a use configuration U (FIG. 4).

The visual display screen 202 has a generally rectangular shape with spaced-apart end portions 208 and spaced-apart side portions 210. As depicted, the spaced-apart end portions 208 extend generally perpendicular to the spaced-apart side portions 210. The hinged members 204 are each attached to a respective one of the spaced-apart end portions 208 of the visual display screen 202, extending effectively an entire distance between the spaced-apart side portions of the visual display screen 202. The hinged members 204 include a central portion 211 and end portions 212 pivotably attached in an end-to-end manner to the central portion 211 by means such as, for example and integral (e.g., molded-in hinge), an attached discrete hinge assembly or other structure for enabling pivoting of each end portion 212 about a respective pivot axis with respect to the central portion 211. The central portion 211 and end portions 212 of each one of the hinge members 204 is essentially non-bending as defined herein.

A pivot axis A1 at a first end 213 of the central portion 211 of each one of the hinged members 204 are aligned and a pivot axis A1 at a second end 214 of the central portion 211 of each one of the hinged members 204 are aligned. Accordingly, the pivot axis (A1, A2) each defines a respective fold line in the visual display screen 202. The inboard support members 207 are each attached at opposing ends thereof to the hinge members 204, extending effectively an entire distance between the spaced-apart end portions 210 of the visual display screen 202. An edge 215 of each one of the inboard support members 207 extends generally parallel with and adjacent to a respective one of the pivot axes (A1, A2) and, thus, extend generally parallel with and adjacent to a respective one of the fold lines of the visual display screen 202.

Referring to FIG. 5, each outboard support member (one shown) has a sheath 216 and a formed strip 218 disposed within the sheath 216 (e.g., sleeve formed form a polymeric material). The formed strip 218 provides self-biasing and self-supporting functionality as discussed above. The sheath 216 is attached to the visual display screen 202 by means such as, for example, adhesive, thermal bonding, stitching, ultrasonic welding, heat staking, and the like. In this manner, the sheath 216 serves as a means for facilitating attachment of the strip 218 to the visual display screen 202. It is disclosed herein that the sheath 216 may be omitted and the strip 218 may be attached directly to the visual display screen 202. In one embodiment, the inboard support members 207 are of substantially the same construction as the outboard support members 206. However, optionally the outboard support members 206 and inboard support members 207 may be different constructions that both offer self-biasing and self-support functionality.

To facilitate retraction of the visual display screen apparatus 200, the end portions 212 of each hinged member 204 are folded as depicted in FIG. 6 (dotted lines). Then, the central portion 211 of each one of the inboard support members 207 is then folded toward each other as shown in FIG. 6 (solid lines). Accordingly, the inboard support members 207 each act as supports around which the visual display screen 202 is wrapped in a controlled manner. Thus, the inboard support members may be referred to as ‘fold-guides’, which control the folding of the visual display screen 202 and avoid creases that would otherwise form and could damage a viewing surface of the visual display screen 202. Beneficially and advantageously, when in the retracted orientation (i.e., fully folded), the visual display screen 202 of the visual display screen apparatus 200 has an overall area that is as much as one-quarter that when in the open orientation O (FIG. 4). Further reductions in size are possible when the visual display screen apparatus 200 is configured for with additional numbers of foldable segments.

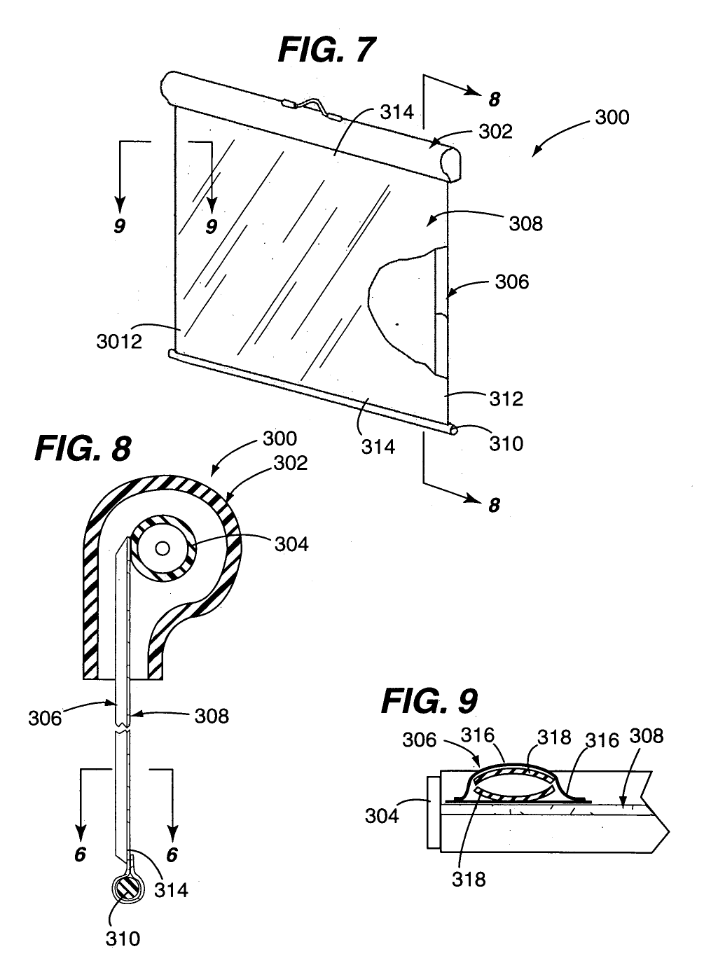

Referring now to FIGS. 7-9, various aspects of a third embodiment of a visual display screen apparatus in accordance with the present invention is shown, which is referred to herein as the pull-out visual display screen apparatus 300. The pull-out visual display screen apparatus 300 includes a housing 302, a drum 304 (FIG. 8), spaced-apart elongated support members 306 (one shown), a visual display screen 308 and a crossmember 310. The drum 304 is rotatably engaged with the housing 302, thus enabling rotation of the drum about a longitudinal axis thereof. The spaced-apart elongated support members 306 are each attached at a first end portion thereof to the drum 304 and at a second end portion thereof to the crossmember 310. The visual display screen 308 has spaced-apart side edge portions 312 and spaced-apart end portions 314. A first one of the edge portions 312 extends generally parallel with a first one of the elongated support members 306 and a second one of the edge portions 312 extends generally parallel with a second one of the elongated support members 306. A first one of the end portions 314 is attached to the drum 304 and a second one of the end portions is attached to the crossmember 310.

As shown in FIG. 9, each one of the elongated support members 306 include a sheath 316 and two opposed formed strips 318 disposed within the sheath 316. The sheath 316 of each one of the elongated support members 306 is attached to the visual display screen 308. In one embodiment (shown), the sheath 316 is attached to the visual display screen along an entire length of the sheath 316. Alternatively, the sheath 316 is attached to the visual display screen along only a portion of the length of the sheath 316. Each one of the formed strips 318 exhibits self-supporting, self-biasing and elastically bendable characteristics as disclosed herein. More specifically, for each one of the elongated support members 306, a concave major surface of each one of the formed strips 318 face each other. The two formed strips 318 of such a multi-strip support member are situated in an opposing manner within the sheath 316 exhibit a relatively high self-biasing force and a relatively low weight. Yet, such a multi-strip support member is still readily bent for enabling folding, rolling or collapsing thereof and an attached visual display screen. Alternatively, the two formed strips of each support member 306 can be situated such that the convex major surface of each one of the formed strips 318 face each. Furthermore, it is disclosed herein that each one of the elongated support members 306 may include only one formed strip.

The self-supporting and self-biasing characteristics of the formed strips 318 serve to maintain planarity of the visual display screen 308. It is disclosed herein that the self-supporting characteristic of the formed strips may be such that the elongated support members 306 exhibit sufficient rigidity to support the visual display screen 308 in a substantially flat and planar configuration regardless of the specifying direction in which the visual display screen 308 extends from the housing. For example, with sufficient rigidity, the elongated support members 306 are able to support the visual display screen 308 in a substantially flat and planar configuration when the visual display screen 308 extends from the housing 302 in a horizontal direction or upward direction. It is disclosed herein that self-supporting, self-biasing and elastically bendable characteristics are at least partially dictated by design considerations such as, for example, thickness of the formed strip, flexural modulus of the formed strip material, degree of curvature of the formed strip, etc)

The visual display screen 308 is made from a conformable material thereby allowing the visual display screen 308 to be rolled onto and unrolled from the drum 304 in conjunction with the elongated support members 306. The elastically bendable characteristic of the formed strips 318 allows the formed strips 318 to each transition from having an arcuate cross-sectional shape to a flat cross-sectional shape as they are rolled onto the drum 304. When the elongated support members are unrolled form the drum 304, the self-biasing and self-supporting characteristics of the formed strips 318 enable the elongated support members 306 to extend from the housing 302 in an effectively unbent and rigid manner such that the attached visual display screen is maintained in a substantially flat, planar manner.

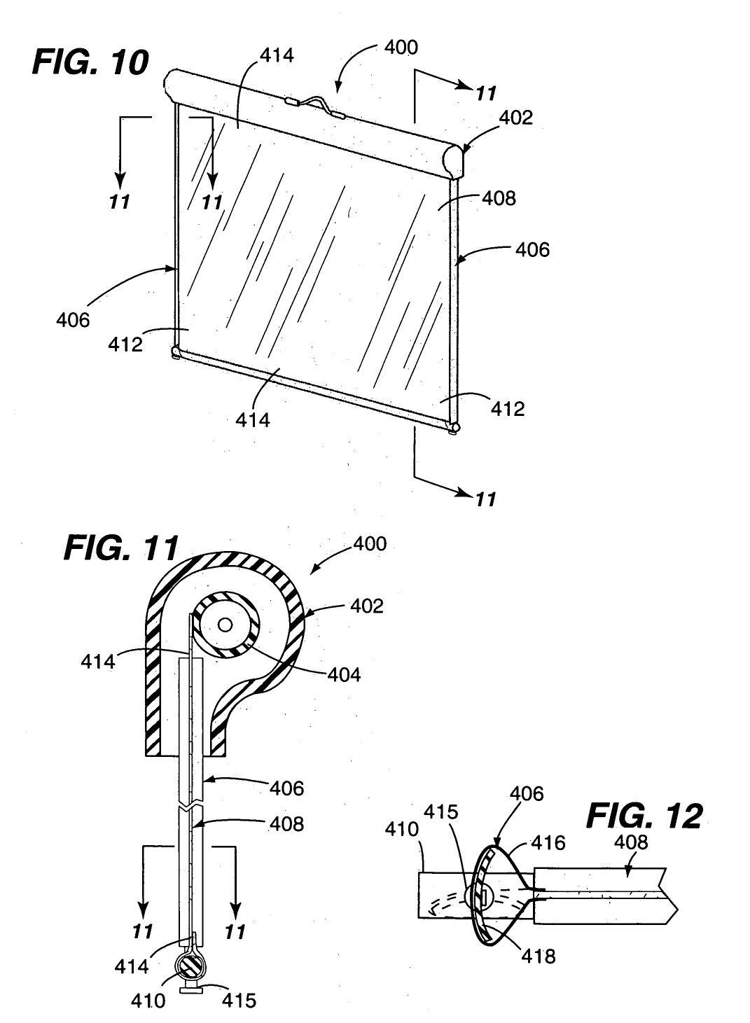

Referring to FIGS. 10-12, various aspects of a fourth embodiment of a visual display screen apparatus in accordance with the present invention is shown, which is referred to herein as the high-planarity pull-down visual display screen apparatus 400. The high-planarity visual display screen apparatus 400 includes a housing 402, a drum 404 (FIG. 8), spaced-apart elongated support members 406, a visual display screen 408 and a crossmember 410. The drum 404 is rotatably engaged with the housing 402, thus enabling rotation of the drum about a longitudinal axis thereof. The spaced-apart elongated support members 406 are each attached at a first end portion thereof to the drum 404 and at a second end portion thereof to the crossmember 410. The visual display screen 408 has spaced-apart side edge portions 412 and spaced-apart end portions 414. A first one of the edge portions 412 extends generally parallel with a first one of the elongated support members 406 and a second one of the edge portions 412 extends generally parallel with a second one of the elongated support members 406. A first one of the end portions 414 is attached to the drum 404 and a second one of the end portions is attached to the crossmember 410.

As shown in FIG. 12, each one of the elongated support members 406 includes a sheath 416 and a formed strip 418 disposed within the sheath 416. The sheath 416 of each one of the elongated support members 406 is attached to the visual display screen 408. In one embodiment (shown), the sheath 416 is attached to the visual display screen along an entire length of the sheath 416.

Alternatively, the sheath 416 is attached to the visual display screen along only a portion of the length of the sheath 416. Each one of the formed strips 418 exhibits self-supporting, self-biasing and elastically bendable characteristics as disclosed herein. It is disclosed herein that each support member 406 may include more than one formed strip.

The self-supporting and self-biasing characteristics of the formed strips 418 serve to maintain planarity of the visual display screen 408. It is disclosed herein that the self-supporting characteristic of the formed strips may be such that the elongated support members 406 exhibit sufficient rigidity to support the visual display screen 408 in a substantially flat and planar configuration regardless of the specifying direction in which the visual display screen 408 extends from the housing. For example, with sufficient rigidity, the elongated support members 406 are able to support the visual display screen 408 in a substantially flat and planar configuration when the visual display screen 408 extends from the housing 402 in a horizontal direction or upward direction. It is disclosed herein that self-supporting, self-biasing and elastically bendable characteristics are at least partially dictated by design considerations such as, for example, thickness of the formed strip, flexural modulus of the formed strip material, degree of curvature of the formed strip, etc)

The visual display screen 408 is made from a conformable material thereby allowing the visual display screen 408 to be rolled onto and unrolled from the drum 404 in conjunction with the elongated support members 406. The elastically bendable characteristic of the formed strips 418 allows the formed strips 418 from having an arcuate cross-sectional shape to having a flat cross-sectional shape as they are rolled onto the drum 404. When the elongated support members are unrolled form the drum 404, the self-biasing and self-supporting characteristics of the formed strips 418 enable the elongated support members 406 to extend from the housing 402 in an effectively unbent and rigid manner such that the attached visual display screen is maintained in a substantially flat, planar manner.

The high-planarity pull-down visual display screen apparatus 400 is configured for enabling the formed strip 408 of each support member 406 to be rotatable between a first orientation and a second orientation. As depicted in FIGS. 11 and, 12, each formed strip is attached to a rotation control device 415 and the rotation control device 415 is rotatably attached to the cross member 410 such that rotation on the rotation control device 415 causes rotation of the attached formed strip 408. In the first orientation, major faces of the formed strip 408 are generally non-coplanar with a major face of an unrolled portion of the visual display screen 408. Such non-coplanar-orientation of the formed strip serves to limit deflection of the visual display screen thus enhancing planarity of the unrolled portion of the visual display screen 408. In the second orientation, major faces of the formed strips 408 are substantially co-planar with the major face of the unrolled portion of the visual display screen thereby enabling the visual display screen and the elongated support members to be rolled onto the drum.

Optionally, in another embodiment similar to the embodiment depicts in FIGS. 10-12, the support members 406 are pivotally and directly attached to respective ones of the edge portions 412 of the visual display screen and the, rotation control device 415 is omitted. In such an embodiment, the support member, which may or may not include a sheath, is pivotable between first orientation and the second orientation discussed above in reference to FIGS. 10-12.

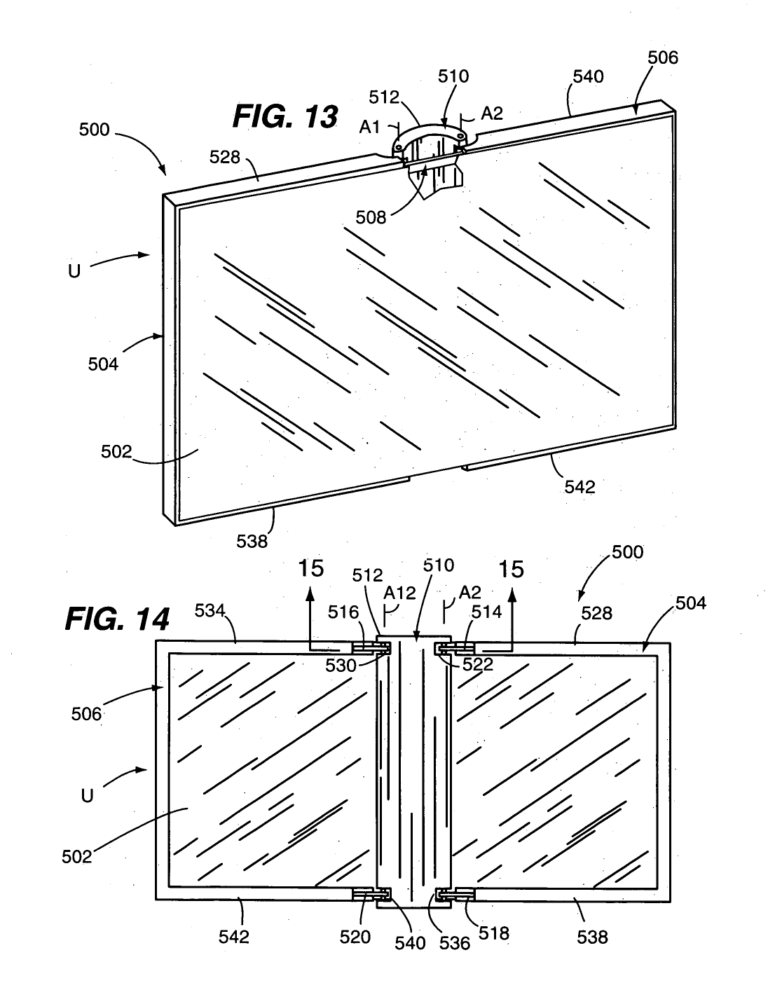

Referring to FIGS. 13-16, various aspects of a fourth embodiment of a visual display screen apparatus in accordance with the present invention is shown, which is referred to herein as the hinged visual display screen apparatus 500. The hinged visual display screen apparatus 500 includes a visual display screen 502, a first frame structure 504, a second frame structure 506, an elongated support member 508 and a hinge assembly 510. The hinge assembly 510 is connected between the first frame structure 504 and the second frame structure 506 for enabling the frame structures (504, 506) to independently pivot relative to each other. The visual display screen 502 is attached to the frame structures in a manner wherein at least a portion of the visual display screen is viewable for serving as a surface upon which media is displayed. The visual display screen 502 is constructed from a foldable material such that the visual display screen 502 is unfolded when a viewable portion of the visual display screen 502 (i.e., portions that are not covered or otherwise obstructed from view) is In a use configuration U (FIGS, 13-15) and is folded when a view able portion of the visual display screen 502 is in a retracted configuration R (FIG. 16).

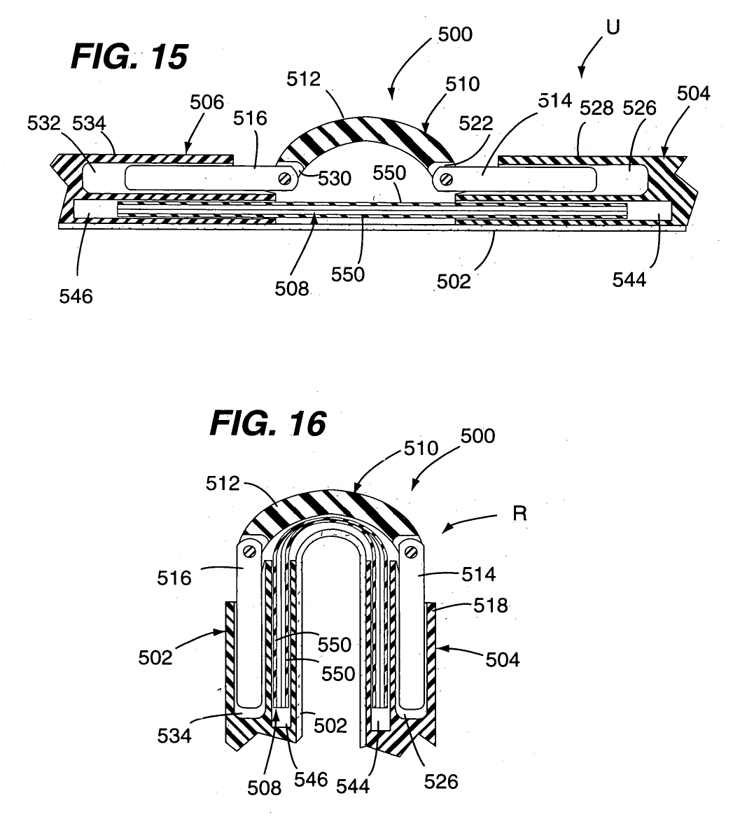

The hinge assembly 510 includes a hinge linkage member 512, a first hinge member 514, a second hinge member 516, a third hinge member 518 and a fourth hinge member 520. The first hinge member 514 is pivotably attached at a first end portion thereof to a first attachment portion 522 of the hinge linkage member 512 and is slideable engaged at a second end portion thereof within a hinge member channel 526 (FIGS. 15 and 16) of an upper frame member 528 of the first frame structure 504. The second hinge member 514 is pivotably attached at a first end portion thereof to a second attachment portion 530 of the hinge linkage member 512 and is slideable engaged at a second end portion thereof within a hinge member channel 532 of an upper frame member 534 of the second frame structure 506. The third hinge member 518 is pivotably attached at a first end portion thereof to a third attachment portion 536 of the hinge linkage member 512 and is slideable engaged at a second end portion thereof within a hinge member channel (not shown) of a lower frame member 538 of the first frame structure 504. The fourth hinge member 520 is pivotably attached at a first end portion thereof to a fourth attachment portion 540 of the hinge linkage member 512 and is slideable engaged at a second end portion thereof within a hinge member channel (not shown) of a lower frame member 542 of the second frame structure 506. Although not shown, the hinge member channels in the lower frame members (538, 542) are the same in configuration as the hinge member channels (526, 532) in the upper frame members (528, 534). The first hinge member 514 and the third hinge member 518 pivot about a first pivot axis A1 and the second hinge member 516 and the fourth hinge member 520 pivot about a second pivot axis A2. As shown in FIGS. 13 and, 14, the first pivot axis A1 is spaced apart from and extends generally parallel to the second pivot axis A2. Thus, when the first frame structure 504 and the second frame structure 506 are pivoted with respect to each other, translation between the first and second frame structures (504, 506) is provided for. Such translation precludes stretching and/or over-stressing of the visual display screen 502 at the fold location of the visual display screen 502 (i.e., the portion of the visual display screen 502 extending between the frame structures (504, 506)) when the frame structures (504, 506) are moved between the open and closed orientations.

The elongated support member 508 is connected between the first frame structure 504 and the second frame structure 506 for biasing the frame support structures (504, 506) to the use position U and positioning the frame support structures (504, 506) in the use position U. A first end portion of the elongated support member 508 is positioned within a support member channel 544 of the upper frame member 528 of the first frame structure 504 and a second end portion of the elongated support member 508 is positioned within a support member channel 546 of the upper frame member 528 of the first frame structure 504.

The elongated support member 508 is depicted in FIGS. 15 and 16 as including one or two formed strips 550. Each one of the formed strips 550 exhibits self-supporting, self-biasing and elastically bendable characteristics as disclosed herein. More specifically, for each one of the elongated support members 306, the concave major surface of each one of the formed strips 550 face each other. Alternatively, the two formed strips 550 of the elongated support member 508 can be situated such that the convex major surface of each one of the formed strips 550 face each. Jointly, the two formed strips 550 of the elongated support member 568 exhibit a relatively high self-biasing force and a relatively low weight. Yet, the two formed strips 550 are readily bent for enabling pivoting of the frame structures (504, 506). It is disclosed herein that the elongated support member 508 may be imparted with bi-stable characteristics for enabling the elongated support member 508 to toggle the frame structures between the open configuration O and retracted configuration R. Furthermore, it is disclosed herein that support member 506 may include only one formed strip and/or may have the one or more formed strips disposed within a sheath.

It is disclosed herein that the elongated support member 508 may include only one formed strip 550.

While it is shown in FIGS. 15 an 16 that the hinge members (514, 516, 518, 520) are slideably attached to respective frame members (528, 534, 538, 542), it is disclosed herein that, optionally, the first and third hinge members (514, 518) may be fixedly attached to the first and third frame members, (528, 538) or the second and fourth hinge members (516, 520) may be fixedly attached to the second and fourth frame members (534, 542). Thus, it is disclosed herein that only one of the frame structures (504, 506) have the frame members slideably attached thereto in embodiments wherein the visual display screen is fixedly attached.(i.e., not slideable in use) to the frame structures (504, 506) for enabling displacement of the frame structures (504, 506) during relative movement therebetween.

In another embodiment of the present invention (not shown), which is a derivative of the embodiment shown in FIGS. 13-16; the hinge members (514, 516, 518, 520) are fixedly (e.g., non-slideably) attached to respective frame members (528,534,538,542) and the visual display screen is slideably (i.e., movably) attached to one of both of the frame structures (504, 506). A first support member is attached to and extends along an upper edge portion of the visual display screen 502. A second support member is attached to and extends along a lower edge portion of the visual display screen 502. The first support member is slideably (i.e., displaceably) attached to upper frame members (528, 534) and the second support member is slideably (i.e., displaceably) attached to the lower frame members (538, 542). In one specific example, respective end portions of the first support member are slideably captured within a channel of the first and second frame members (528, 534) and respective end portions of the second support member are slideably captured within a channel of the third and fourth frame members (538, 542). In another specific example, a first end portion of the first support member and the second support member is slideably captured within a channel of the first and third frame members (528, 538), respectively, and a second end portion of 24. the first support member and the second support member is fixedly attached top the second and fourth frame members (534, 542), respectively. In this manner, the visual display screen 502 is secured to the frame structures (504, 506) in a tensioned/taut manner, the support members act to bias the frame structures (504, 506) to the open orientation and/or closed orientation, and the visual display screen 502 is translatable with respect to at least one of the frame structures (504, 506) for precluding stretching and/or over-stressing of the visual display screen 502 at the fold location of the visual display screen 502 when the frame structures (504, 506) are moved between the open and closed orientations.

Embodiments of the present invention disclosed above incorporate a formed strip that has an as manufactured arcuate cross-sectional shape. Such an as manufactured formed strip maintains its arcuate cross-sectional shape without the need for externally applied forces for doing so. However, it is disclosed herein that embodiments of an externally stressed strip of material having an arcuate cross-sectional profile and exhibiting self-biasing, self-supporting and elastically bendable characteristics may be used in place of an as manufactured formed strip. As manufactured formed strips and externally-stressed formed strips are both examples of formed strips in accordance with the present invention.

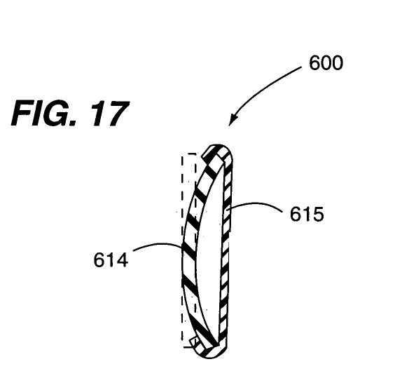

Referring now to FIG. 17, an embodiment of an externally-stressed formed strip in accordance with the present invention is shown, which is referred to herein as the externally-stressed formed strip 600. The externally-stressed formed strip 600 includes a strip 614 of elastically bendable material (e.g., spring steel) and a stressing structure 615. The strip 614 of elastically bendable material has a generally flat cross sectional profile when no external forces are applied. The stressing structure 615 is engaged with spaced-apart longitudinal edge portions 617 of the strip 614 of elastically bendable material such that the stressing structure 615 causes the strip 614 of elastically bendable material to have an arcuate cross-sectional shape so long as the stressing member remains attached to the strip 614 of elastically bendable material. More specifically, the stressing structure 615 applies force on the strip 614 of elastically bendable material for creating and retaining the arcuate cross-sectional shape. A strip of fabric with suitable tensile strength, a strip of polymeric sheet with suitable tensile strength and an extruded or molded strip of polymeric material are examples of the stressing structure 615. The stressing structure 615 may be attached by any number of different means (e.g., adhesive, heat stacking, ultrasonic welding, formed engagement channels/ridges, etc). It is disclosed herein that the stressing structure 615 may be engaged with a visual display screen of a visual display screen apparatus in accordance with the present invention by means such as, for example, adhesive, heat stacking, ultrasonic welding, formed engagement channels/ridges, etc. It is also disclosed herein that the stressing member 615 may be a sheath (e.g., a sleeve or tube) whose internal dimensions are such that insertion of the strip 614 of elastically bendable material causes the sheath to apply sufficient force on the with spaced-apart longitudinal edge portions 617 of the elastically bendable material whereby the strip 614 of elastically bendable material has an arcuate cross-sectional shape while within the sheath.

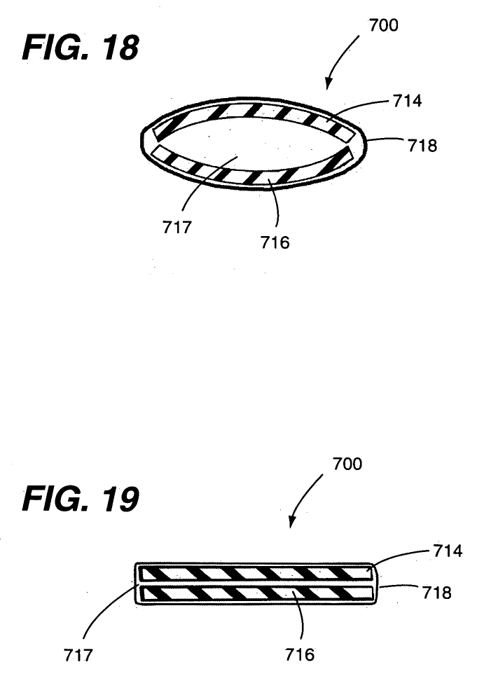

Now referring to FIGS. 18 and 19, the elongated member 700 shown in FIG. 18 includes a first formed strip 714, a second formed strip 716 and a sheath 718. As shown, the formed strips (714, 716) both have an arcuate cross-sectional shape, a concave face and a convex face. The formed strips (714, 716) are disposed within an interior space 717 of the sheath 718 such that the concave face of the first formed strip 714 faces the concave face of the second formed strip 716. Both of the formed strips (714, 716) exhibit self-supporting, self-biasing and elastically bendable characteristics as disclosed herein. The interior space 717 of the sheath 718 is constructed in a manner (i.e., essentially sealed from an ambient environment) enabling the interior space 717 to be selectively maintained at a gas pressure above an external gas pressure (e.g., ambient atmospheric pressure) and below the external gas pressure. By sufficiently reducing the gas pressure in the interior space 717 of the sheath 718 below the external gas pressure, the external gas pressure causes the sheath 718 to collapse and correspondingly exerts a collapsing force (i.e., dictated by the differential in pressure between the external gas pressure and the gas pressure within the interior space 717 of the sheath 718) on the formed strips (714, 716). The formed strips (714, 716) are configured such that the collapsing force is sufficient to flatten the formed strips whereby they attain a generally flat cross-sectional shape (FIG. 19). Such flattening of the formed strips (714, 716) allow the formed strips (714, 716) to be more readily rollable and/or foldable as compared to being rolled and/or folded with an arcuate cross-sectional shape.

Conversely, the formed strips (714, 716) may be manufactured to have a flat cross-sectional shape similar to that shown in FIG. 19. Increasing the gas pressure within the interior space 717 of the sheath 716 to be above the external gas pressure causes the two flat formed strips (714, 716) to attain an arcuate cross-sectional shape as shown in FIG. 18. Thus, it is disclosed herein that selectively applying and removing gas pressure from within the interior space 717 of the sheath may be used to selectively create and remove the arcuate cross sectional shape of the formed strips (714, 716), thereby applying and removing the disclosed mechanical self-biasing characteristic of an formed strip in accordance with the present invention.

In a similar manner, the single formed strip 614 of FIG. 17 with a bonded sheath 615 that is not sufficiently tensionied to cause the strip 614 to have an arcuate cross-sectional shape could exhibit a similar effect of making the flat strip become selectively arcuate by applying gas pressure within an interior space between the sheath 615 and the strip 614.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A visual display screen apparatus, comprising:
a visual display screen constructed from material exhibiting suitable conformability for enabling the visual display screen to be at least one of rollable, collapsible and foldable, wherein said material is at least one of rolled, collapsed and folded when a viewable portion of the visual display screen is in a retracted configuration and is generally flat when the viewable portion of the visual display screen is in a use configuration; and
an elongated support member having the visual display screen engaged therewith, Wherein the elongated support member includes a strip of elastically bendable material, wherein said strip of material exhibits a self-supporting characteristic when in an non-bent configuration such that the elongated support member extends in an effectively straight and rigid manner thereby supporting the viewable portion of the visual display screen in the use configuration and wherein said strip of material exhibits a self-biasing characteristic when a bending force is applied thereto for resiliently moving said strip of material from the non-bent configuration to a bent configuration thereby enabling the viewable portion of the visual display screen to be changed to the retracted configuration.

2. The visual display screen apparatus of claim 1 wherein:
the elongated member includes a sheath; and
at least a portion of said strip of material is disposed within the sheath.

3. The visual display screen apparatus of claim 2 wherein the sheath is attached to the visual display screen.

4. The visual display screen apparatus of claim 1 wherein:
a non-bent portion of said strip of material has an arcuate cross-sectional shape;
a bent portion of said strip of material is elastically deformed to include an essentially flat cross-sectional shape; and
said elastically bendable material and the arcuate cross sectional profile jointly cause the elongated support member to be self-biased to the non-bent configuration.

5. The visual display screen apparatus of claim 4 wherein:
said strip of material has an approximately constant cross-sectional thickness; and
said elastically bendable material, the arcuate cross sectional profile and the approximately constant cross-sectional thickness jointly cause the elongated support member to be self-biased to the non-bent configuration.

6. The visual display screen apparatus of claim 5 wherein:
said strip includes an arcuate cross sectional profile along a portion of its length and includes internal bending stresses along the portion of its length that act to urge the specific portion of length into a bent configuration; and
said portion of length of said strip is configured such that the level of applied bending force required to cause the arcuate cross-sectional shape to flatten and, thus, enable bending is greater than said internal bending stresses thereby providing said portion of length of said strip with self-supporting characteristics.

7. The visual display-screen apparatus of claim 1 wherein:
said strip includes an arcuate cross sectional profile along a portion of its length and includes internal bending stresses along the portion of its, length that act to urge the specific portion of length into a bent configuration; and
said portion of length of said strip is configured such that the level of applied bending force required to cause the arcuate cross-sectional shape to flatten and, thus enable bending is greater than said internal bending stresses thereby providing said portion of length of said strip with self-supporting characteristics.

8. The visual display screen apparatus of claim 1, further comprising:
a hinge assembly including a hinge linkage member having spaced apart attachment portions, a first hinge member pivotably attached to a first one of said attachment portions in a manner enabling the first hinge member to pivot about a pivot axis of the first one of said attachment portions and a second hinge member pivotably attached to a second one of said attachment portions in a manner enabling the second hinge member to pivot about a pivot axis of the second one of said attachment portions, wherein said hinge members are each attached to at least one of the visual display screen and said strip of material and wherein the first pivot axis is spaced apart from and extends generally parallel to the second pivot axis.

9. The visual display screen apparatus of claim 8 wherein:
a non-bent portion of said strip of material has an arcuate cross-sectional shape;
a bent portion of said strip of material is elastically deformed to include an essentially flat cross-sectional shape; and
said elastically bendable material and the arcuate cross sectional profile jointly cause the elongated support member to be self-biased to the non-bent configuration.

10. The visual display screen apparatus of claim 9 wherein:
said strip of material has an approximately constant cross-sectional thickness; and
said elastically bendable material, the arcuate cross sectional profile and the approximately constant cross-sectional thickness jointly cause the elongated support member to be self-biased to the non-bent configuration.

11. The visual display screen apparatus of claim 1, further comprising
a hinge assembly including a hinge linkage member having spaced apart attachment portions, a first hinge member pivotably attached to a first one of said attachment portions in a manner enabling the first hinge member to pivot about a pivot axis of the first one of said attachment portions and a second hinge member pivotably attached to a second one of said attachment portions in a manner enabling the second hinge member to pivot about a pivot axis of the second one of said attachment portions, wherein the first pivot axis is spaced apart from and extends generally parallel to the second pivot axis; and
two spaced-apart frame structures, wherein the visual display screen is attached to said frame structures, wherein the first hinge member is slideably engaged with a first one of said frame structures and wherein the second hinge member is slideably engaged with a second one of said frame structures.

12. A visual display screen assembly, comprising:
a visual display screen constructed from material exhibiting suitable conformability for enabling the visual display screen to be at least one of rollable, collapsible and foldable, wherein said material is at least one of rolled, collapsed and folded when a viewable portion of the visual display screen is in a retracted configuration and is generally flat when the viewable portion of the visual display screen is in a use configuration; and
an elongated support member having the visual display screen engaged therewith, wherein the elongated support member includes a strip of elastically bendable material having spaced-apart major surfaces, wherein a first one of said major surfaces has a convex cross-sectional shape and a second one of said major surfaces has a concave cross-sectional shape, wherein said elastically bendable material and said major surface profiles jointly enable said strip of material to exhibit self-biasing, self-supporting and elastically bendable characteristics whereby the elongated support member is self-biased to a substantially straight, essentially rigid orientation when the viewable portion of the visual display screen is in the use configuration and is elastically bent when the viewable portion of the visual display screen is in the retracted configuration.

13. The visual display screen apparatus of claim 12 wherein:
the elongated member includes a sheath; and
at least a portion of said strip of material is, disposed within the sheath.

14. The visual display screen apparatus of claim 13 wherein the sheath is attached to the visual display screen.

15. The visual display screen apparatus of claim 12 wherein said strip of material has an approximately constant cross-sectional thickness.

16. The visual display screen apparatus of claim 15 wherein:
said strip includes an arcuate cross sectional profile along a portion of its length and includes internal bending stresses along the portion of its length that act to urge the specific portion of length into a bent configuration; and
said portion of length of said strip is configured such that the level of applied bending force required to cause the arcuate cross-sectional shape to flatten and, thus, enable bending is greater than said internal bending stresses thereby providing said portion of length of said strip with self-supporting characteristics.

17. The visual display screen apparatus of claim 12 wherein:
said strip includes an arcuate cross sectional profile along a portion of its length and includes internal bending stresses along the portion of its length that act to urge the specific portion of length into a bent configuration; and
said portion of length of said strip is configured such that the level of applied bending force required to cause the arcuate cross-sectional shape to flatten and, thus, enable bending is greater than said internal bending stresses thereby providing said portion of length of said strip with self-supporting characteristics.

18. The visual display screen apparatus of claim 12, further comprising:
a hinge assembly including a hinge linkage member having spaced apart attachment portions, a first hinge member pivotably attached to a first one of said attachment portions in a manner enabling the first hinge member to pivot about a pivot axis of the first one of said attachment portions and a second hinge member pivotably attached to a second one of said attachment portions in a manner enabling the second hinge member to pivot about a pivot axis of the second one of said attachment portions, wherein said hinge members are each attached to at least one of the visual display screen and said strip of material and wherein the first pivot axis is spaced apart from and extends generally parallel to the second pivot axis.

19. The visual display screen apparatus of claim 12 wherein:
a non-bent portion of said strip of material has an arcuate cross-sectional shape;
a bent portion of said strip of material is elastically deformed to include an essentially flat cross-sectional shape; and
said elastically bendable material and the arcuate cross sectional profile jointly cause the elongated support member to be self-biased to the non-bent configuration.

20. The visual display screen apparatus of claim 19 wherein:
said strip of material has an approximately constant cross-sectional thickness; and
said elastically bendable material, the arcuate cross sectional profile and the approximately constant cross-sectional thickness jointly cause the elongated support member to be self-biased to the non-bent configuration.

21. The visual display screen apparatus of claim 12, further comprising a hinge-assembly including a hinge linkage member having spaced apart attachment portions, a first hinge member pivotably attached to a first one of said attachment portions in a manner enabling the first hinge member to pivot about a pivot axis of the first one of said attachment portions and a second hinge member pivotably attached to a second one of said attachment portions in a manner enabling the second hinge member to pivot about a pivot axis of the second one of said attachment portions, wherein the first pivot axis is spaced apart from and extends generally parallel to the second pivot axis; and
spaced-apart frame structures, wherein the visual display screen is attached to said frame structures, wherein the first hinge member is slideably engaged with a first one of said frame structures and wherein the second hinge member is slideably engaged with a second one of said frame structures.

22. A visual display screen assembly, comprising:
a visual display screen constructed from material exhibiting suitable conformability for enabling the visual display screen to be at least one of rollable, collapsible and foldable, wherein said material is at least one of rolled, collapsed and folded when a viewable portion of the visual display screen is in a retracted configuration and is generally flat when the viewable portion of the visual display screen is in a use configuration; and
an elongated support member including an elastically bendable self-supporting strip of material having spaced-apart major faces, wherein said strip of material extends at least partially along a length of the viewable portion of the visual display screen and wherein when the viewable portion of the visual display screen is in the use configuration said strip of material, is rotatable between a first orientation such that said major faces of said strip of material are generally non-coplanar with a major face of the viewable portion of the visual display screen and a second orientation such that said major faces of said strip of material are substantially co-planar with the major face of the viewable portion of the visual display screen.

23. The visual display screen apparatus of claim 22 wherein:
the visual display screen has spaced-apart side edge portions;
the elongated support member is attached to a first one of said side edge portions of the visual display screen.

24. The visual display screen apparatus of claim 22, further comprising:
a crossmember, wherein the visual display screen has spaced-apart side edge portions and spaced-apart end portions, wherein the elongated support member extends generally parallel with a first one of said edge portions of the visual display screen, wherein a first one of said end portions of the visual display screen is attached to the crossmember and wherein said strip of material is rotatably attached to the crossmember.

25. The visual display screen apparatus of claim 24 wherein the elongated support member is attached to the first one of said side edge portions of the visual display screen.

26. The visual display screen apparatus of claim 22 wherein the elongated support member includes a strip of elastically bendable material, wherein said strip of material exhibits a self-supporting characteristic when in an non-bent configuration such that the elongated support member extends in an effectively straight and rigid manner thereby supporting the viewable portion of the visual display screen in the use configuration and wherein said strip of material exhibits a self-biasing characteristic when a bending force is applied thereto for resiliently moving said strip of material from the non-bent configuration to a bent configuration thereby enabling the viewable portion of the visual display screen to be changed to the retracted configuration.

27. The visual display screen apparatus of claim 26 wherein:
said strip of material has an approximately constant cross-sectional thickness;
a non-bent portion of said strip of material has an arcuate cross-sectional shape;
a bent portion of said strip of material is elastically deformed to include an essentially flat cross-sectional shape; and
said elastically bendable material, the approximately constant cross-sectional thickness and the arcuate cross sectional profile jointly cause the elongated support member to be self-biased to the non-bent configuration.

28. A visual display screen apparatus, comprising:
a visual display screen constructed from a foldable material, wherein said material is folded when a viewable portion of the visual display screen is in a retracted configuration and is unfolded when the viewable portion of the visual display screen is in a use configuration;
spaced-apart frame structures, wherein the visual display screen is attached to said frame structures;
an elongated support member having the visual display screen engaged therewith wherein the elongated support member includes a strip of elastically bendable material having spaced-apart opposed major surfaces, wherein a first one of said major surfaces has a convex cross-sectional shape and a second one of said major surfaces has a concave cross-sectional shape, wherein said elastically bendable material and said major surface configurations jointly enable said strip of material to exhibit self-biasing, self-supporting and elastically bendable characteristics whereby the elongated support member is self-biased to a substantially straight, essentially rigid orientation when the viewable portion of the visual display screen is in the use configuration and is elastically bent when the viewable portion of the visual display screen is in the retracted configuration; and
means for pivoting connected between said frame structures for enabling a first one of said frame structures to pivot with respect to a second one of said frame structures.

29. The visual display screen apparatus of claim 28 wherein:
the elongated member includes a sheath; and
at least a portion of said strip of material is disposed within the sheath.

30. The visual display screen apparatus of claim 29 wherein the sheath is attached to the visual display screen.

31. The visual display screen apparatus of claim 28 wherein said strip of material has an approximately constant cross-sectional thickness.

32. The visual display screen apparatus of claim 31 wherein:
said strip includes an arcuate cross sectional profile along a portion of its length and includes internal bending stresses along the portion of its length that act to urge the specific portion of length into a bent configuration; and
said portion of length of said strip is configured such that the level of applied bending force required to cause the arcuate cross-sectional shape to flatten and, thus, enable bending is greater than said internal bending stresses thereby providing said portion of length of said strip with self-supporting characteristics.

33. The visual display screen apparatus of claim 28 wherein:
said means for pivoting includes a hinge assembly; and
the hinge assembly includes a hinge linkage member having spaced apart attachment portions, a first hinge member pivotably attached to a first one of attachment portions in a manner enabling the first hinge member to pivot about a pivot axis of the first one of said attachment portions and a second hinge member pivotably attached to a second one of said attachment portions in a manner enabling the second hinge member to pivot about a pivot axis of the second one of said attachment portions, wherein the first pivot axis is spaced apart from and extends generally parallel to the second pivot axis.

34. The visual display screen apparatus of claim 33 wherein:
the first hinge member is slideably engaged with a first one of said frame structures; and
the second hinge member is slideably engaged with a second one of said frame structures.

35. The visual display screen apparatus of claim 28 wherein:
said frame structures each include a top frame member, and a bottom frame member spaced apart from the top frame member;
the top frame member of a first one of said frame structures is adjacent the top frame member of a second one of said frame structures;
the bottom frame member of the first one of said frame structures is adjacent the bottom frame member of the second one of said frame structures;
said means for pivoting includes a hinge assembly;
the hinge assembly includes an elongated hinge linkage member extending at least partially between said top and bottom frame members of said frame structures;
the first one of said frame structures is pivotably attached to a first attachment portion of the elongated hinge linkage member such that the first one of said frame structures pivots with respect to the hinge linkage member about a first pivot axis;
the second one of said frame structures is pivotably attached to a second attachment portion of the elongated hinge linkage member such that the second one of said frame structures pivots with respect to the elongated hinge linkage member about a second first pivot axis; and
the first pivot axis is spaced apart from and extends generally parallel to the second pivot axis.

36. The visual display screen apparatus of claim 35 wherein:
the hinge assembly includes a plurality of hinge members;
a first one of said hinge members is slideably engaged at a first end portion thereof to the first one of said frame structures adjacent the top frame member of the first one of said frame structure and is pivotably attached at a second end portion thereof to the first attachment portion of the hinge linkage member;
a second one of said hinge members is slideably engaged at a first end portion thereof to the first one of said frame structures adjacent the bottom frame member of the first one of said frame structure and is pivotably attached at a second end portion thereof to the first attachment portion of the hinge linkage member;
a third one of said hinge members is slideably engaged at a first end portion thereof to the second one of said frame structures adjacent the top frame member of the second one of said frame structure and is pivotably attached at a second end portion thereof to the second attachment portion of the hinge linkage member;
a fourth one of said hinge members is slideably engaged at a first end portion thereof to the second one of said frame structures adjacent the bottom frame member of the second one of said frame structure and is pivotably attached at a second end portion thereof to the second attachment portion of the hinge linkage member.

37. The visual display screen apparatus of claim 36 wherein:
a non-bent portion of said strip of material has an arcuate cross-sectional shape;
a bent portion of said strip of material is elastically deformed to include an essentially flat cross-sectional shape; and
said elastically bendable material and the arcuate cross sectional profile jointly cause the elongated support member to be self-biased to the non-bent configuration.

38. The visual display screen apparatus of claim 37 wherein:
said strip of material has an approximately constant cross-sectional thickness; and
said elastically bendable material, the arcuate cross sectional profile and the approximately constant cross-sectional thickness jointly cause the elongated support member to be self-biased to the non-bent configuration.

39. The visual display screen apparatus of claim 38 wherein:
the first hinge member is slideably engaged with a first one of said frame structures; and
the second hinge member is slideably engaged with a second one of said frame structures.

40. The visual display screen apparatus of claim 28 wherein:
a non-bent portion of said strip of material has an arcuate cross-sectional shape;
a bent portion of said strip of material is elastically deformed to include an essentially flat cross-sectional shape; and
said elastically bendable material and the arcuate cross sectional profile jointly cause the elongated support member to be self-biased to the non-bent configuration.

41. The visual display screen apparatus of claim 40 wherein:
said strip of material has an approximately constant cross-sectional thickness; and
said elastically bendable material, the arcuate cross sectional profile and the approximately constant cross-sectional thickness jointly cause the elongated support member to be self-biased to the non-bent configuration.

42. The visual display screen apparatus of claim 41 wherein:
the first hinge member is slideably engaged with a first one of said frame structures; and
the second hinge member is slideably engaged with a second one of said frame structures.

43. A visual display screen apparatus, comprising:
a housing;
a drum rotatably engaged with the housing;
spaced-apart elongated support members each attached at a first end portion thereof to the drum such that said support members are rollable onto and unrollable from the drum, wherein each one of said support members exhibits a self-supporting characteristic when unrolled from the drum thereby causing an unrolled portion of said support members to extend from the housing in an effectively unbent and rigid manner, and wherein each one of said support members exhibits a elastically bendable characteristic when rolled onto the drum thereby allowing each one of said support members to be rolled on to the drum; and
a visual display screen having spaced-apart side edge portions and spaced-apart end portions, wherein a first one of said edge portions extends generally parallel with a first one of said support members and a second one of said edge portions extends generally parallel with a second one of said support members, wherein a first one of said end portions is attached to the drum and wherein the visual display screen is made from a conformable material thereby allowing the visual display screen to be rolled onto and unrolled from the drum in conjunction with said support members.

44. The visual display screen apparatus of claim 43 wherein:
the first one of said side edge portions is attached to a first one of said support members; and
the second one of said side edge portions is attached to a second one of said support members.

45. The visual display screen apparatus of claim 43, further comprising:
a crossmember attached to a second one of said end portions of the visual display screen, wherein the crossmember extends generally parallel with the drum.

46. The visual display screen apparatus of claim 43 wherein:
each one of said elongated support members includes a strip of elastically bendable material;
said strip of material has an approximately constant cross-sectional thickness; and
unrolled portions of said strip of material has an arcuate cross-sectional shape.

47. The visual display screen apparatus of claim 43 wherein:
each one of said support members includes an elastically bendable self-supporting strip of material having spaced-apart major faces;
said strip of material is rotatable between a first orientation such that said major faces of said strip of material are generally non-coplanar with a major face of the unrolled portion of the visual display screen thereby limiting deflection of the visual display screen and a second orientation such that said major faces of said strip of material are substantially co-planar with the major face of the unrolled portion of the visual display screen thereby enabling the visual display screen and said support members to be rolled onto the drum.

48. The visual display screen apparatus of claim 47, further comprising:
a crossmember attached to a second one of said end portions of the visual display screen, wherein a longitudinal axis of the crossmember extends generally parallel with a longitudinal axis of the drum and wherein said strip of material is rotatably attached to the crossmember.

49. The visual display screen apparatus of claim 48 wherein:
the first one of said side edge portions is attached to a first one of said support members; and
the second one of said side edge portions is attached to a second one of said support members.

50. The visual display screen apparatus of claim 49 wherein:
each one of said elongated support members includes a strip of elastically bendable material;
said strip of material has an approximately constant cross-sectional thickness; and
unrolled portions of said strip of material has an arcuate cross-sectional shape.
